(19) United States
(12) Patent Application Publication
(10) Pub. No.: US 2024/0084642 A1
(43) Pub. Date: Mar. 14, 2024

(54) INSULATED GLAZING UNITS AND METHODS OF PRODUCING THE SAME

(71) Applicant: JELD-WEN, Inc., Charlotte, NC (US)

(72) Inventors: Jason Kantola, Klamath Falls, OR (US); Bryan Pape, Klamath Falls, OR (US); Yuxuan Gong, Lewis Center, OH (US)

(73) Assignee: JELD-WEN, Inc., Charlotte, NC (US)

(21) Appl. No.: 17/930,627

(22) Filed: Sep. 8, 2022

(51) Int. Cl. E06B 3/663; E06B 3/66; E06B 3/677

(52) U.S. Cl. CPC E06B 3/66347; E06B 3/6612; E06B 3/6775; E06B 2003/66385

(57) ABSTRACT

Methods are provided for producing insulated glazing units. The insulated glazing unit includes a first pane including a first outer edge, a second pane that overlaps the first pane and that includes a second outer edge, an outer edge sealing spacer arrangement that seals and maintains an inter-pane space between the first pane and the second pane, the outer edge sealing spacer arrangement including: a seat that receives the first outer edge and the second outer edge and that extends along the first outer edge and the second outer edge, a shoe that receives the seat, and a coupling between the seat and the shoe configured to maintain the seat within the shoe.

### INTRODUCTION

The technical field generally relates to a fenestration unit and, more particularly, relates to an insulated glazing unit for a fenestration unit that include at least two panes sealed along edges thereof with an outer edge sealing spacer arrangement.

A fenestration unit may include a frame (e.g., a rectangular frame) that supports one or more other members of the unit. For example, a panel of the fenestration unit (e.g., an active panel of a slider door or a window unit) may include a frame that supports a glazing unit, a door skin, or other component of the panel. Fenestration units having transparent panels may include windows, glass doors, sidelites, skylites, etc. Preferably, fenestration units are robust, weather resistant, and highly functional. Furthermore, these units are preferably manufacturable in an efficient and cost-effective manner. However, providing high-quality fenestration units is often associated with higher costs, longer manufacture time, higher part counts, and/or other challenges. Sealing these fenestration units with a sealant material may contribute substantially to these costs, inefficiencies, etc.

Thus, it is desirable to provide a high-quality fenestration unit that is highly weather resistant and robust. Furthermore, it is desirable to provide such units at reduced costs, using features that increase manufacturing efficiency. Other desirable features and characteristics of the present disclosure will become apparent from the subsequent detailed description and the appended claims, taken in conjunction with the accompanying drawings and this background discussion.

### SUMMARY

An insulated glazing unit is provided, for example, for use in a fenestration unit. In one embodiment, the insulated glazing unit includes a first pane with a first outer surface facing in a first exterior direction and a second outer surface facing in a first interior direction, the first pane including a first outer edge, a second pane that overlaps the first pane and that includes a first outer surface facing in a second interior direction that is aligned with and opposite the first interior direction and a second outer surface facing in a second exterior direction that is aligned with and opposite the first exterior direction, the second pane including a second outer edge, an outer edge sealing spacer arrangement that seals and maintains an inter-pane space between the first pane and the second pane, the outer edge sealing spacer arrangement including: a seat that receives the first outer edge and the second outer edge and that extends along the first outer edge and the second outer edge, a shoe that receives the seat, and a coupling between the seat and the shoe configured to maintain the seat within the shoe.

A method is provided for producing an insulated glazing unit. In one embodiment, the method includes providing a first pane and a second pane, the first pane including a first outer edge and the second pane including a second outer edge, receiving the first outer edge and the second outer edge into a seat such that a first outer surface of the first pane is facing in a first exterior direction, a second outer surface of the first pane is facing in a first interior direction opposite the first exterior direction, the second pane overlaps the first pane, a first outer surface of the second pane is facing in a second interior direction aligned with and opposite the first interior direction, and a second outer surface of the second pane is facing in a second exterior direction aligned with and opposite the first exterior direction, wherein the seat extends along the first outer edge and the second outer edge, receiving the seat in a shoe, and securing the seat in the shoe with a coupling between the seat and the shoe to define an outer edge sealing spacer arrangement that substantially seals and maintains an inter-pane space between the first pane and the second pane.

### BRIEF DESCRIPTION OF THE DRAWINGS

The exemplary embodiments will hereinafter be described in conjunction with the following drawing figures, wherein like numerals denote like elements, and wherein:

FIG. 1 is a front view of a glazing units in accordance with an embodiment;

FIG. 2 is a cross-sectional view of an edge of the glazing unit of FIG. 1;

FIGS. 3-8 are cross-sectional views of exemplary shoes and seats in accordance with various embodiments; and

FIG. 9 is a flowchart illustrating a method of producing a glazing unit in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Broadly, example embodiments disclosed herein include a fenestration unit with a glazing unit that is supported in a frame. The glazing unit may include two, three, four, or more spaced apart panes having perimeter edges thereof sealed with an outer edge sealing spacer arrangement. The outer edge sealing spacer arrangement may be manufactured efficiently and may increase manufacturing efficiency for the fenestration unit.

In some embodiments, the outer edge sealing spacer arrangement may include a seat configured to receive a first outer edge of a first pane of the glazing unit and a second outer edge of a second pane of the glazing unit. Once received, the seat may extend along all or a portion of the first outer edge and the second outer edge. The outer edge sealing spacer arrangement may also include a shoe configured to receive the seat. In some embodiments, a coupling may be provided between the seat and the shoe that is configured to promote a sealing fit between the seat and the shoe, preferably such that an inter-pane space between the first and second panes of the glazing unit is substantially sealed.

Accordingly, the glazing unit may be manufactured efficiently, using relatively few components and, in some embodiments, without using a sealant to seal the inter-pane space between the first pane and the second pane of the glazing unit. The resulting seals may be highly robust, have extended life spans, and the weather resistance of the fenestration unit may be improved.

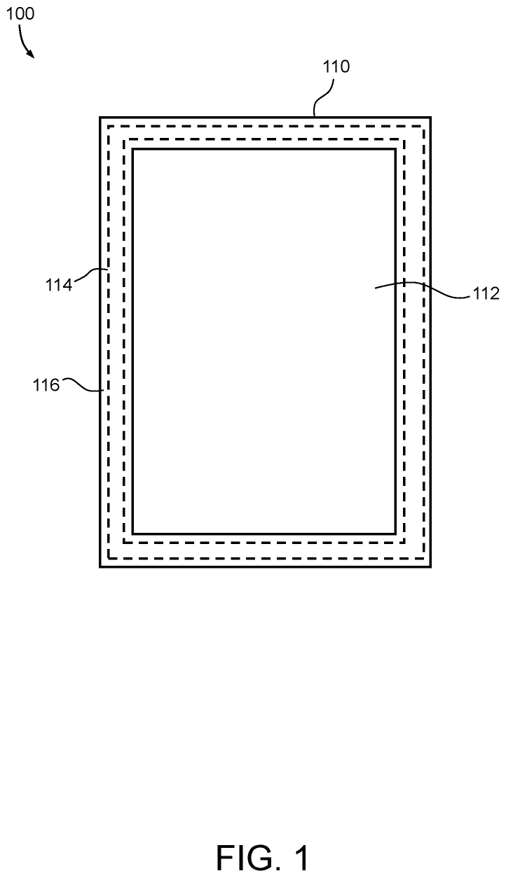

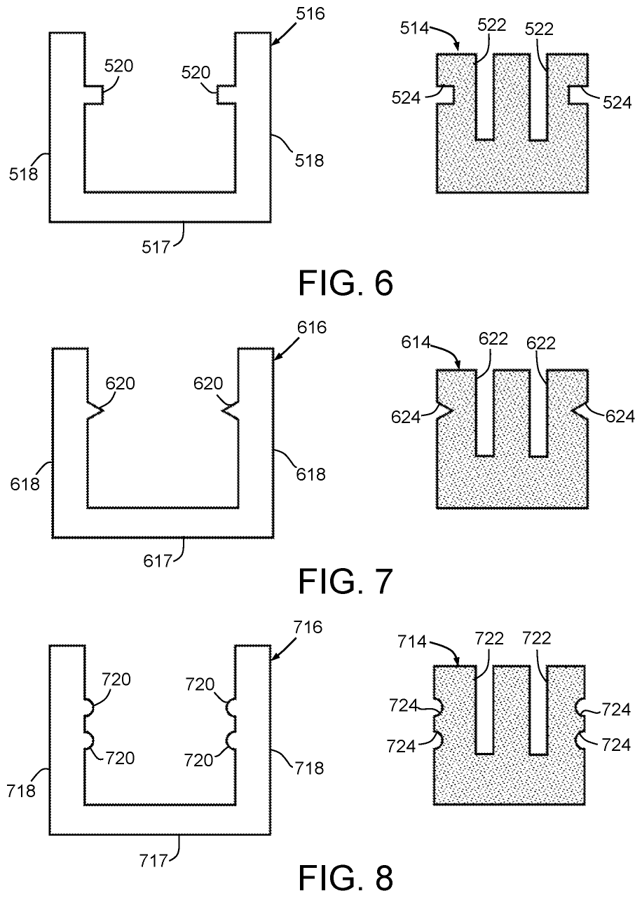

FIGS. 1-9 present an exemplary glazing unit in accordance with various nonlimiting aspects of the present disclosure. It should be noted that these examples are merely for illustrative purposes and the glazing unit of FIGS. 1-9 may have other configurations, including various combinations of the components represented in FIGS. 1-9. The glazing unit may be included in a fenestration unit including, but not limited to, a window, a glazed door, a skylight, a side lite, or other configuration without departing from the scope of the present disclosure. The glazing unit may be included in a frame of the fenestration unit.

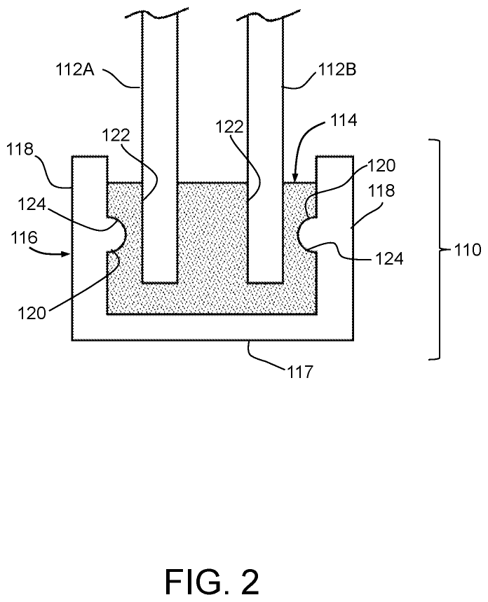

For convenience, consistent reference numbers are used throughout FIGS. 1-9 to identify the same or functionally related/equivalent elements, but with a numerical prefix (1, 2, or 3, etc.) added to distinguish the particular embodiment from other embodiments of the of the figures. In view of similarities between the embodiments, the following discussion of FIGS. 1-9 will focus primarily on aspects of the embodiments that differ from the other embodiments in some notable or significant manner. Other aspects of the embodiments not discussed in any detail can be, in terms of structure, function, materials, etc., essentially as was described for one or more of the other embodiments, including the embodiment of FIGS. 1-2.

As presented in FIGS. 1 and 2, the glazing unit 100 includes a pair of panes 112 referred to herein as a first pane 112A and a second pane 112B. In this example, the first pane 112A and the second pane 112B both have substantially planar, rectangular shapes; however, other shapes are possible and within the scope of the invention. The first pane 112A and the second pane 112B may be formed of various materials, such as those commonly used in the art for glazing units. Nonlimiting examples of suitable materials include various glass materials (e.g., soda-lime glass) and certain transparent or semi-transparent polymeric materials. Processes for producing the pair of panes 112 are well known in the art and therefore will not be discussed in detail herein. A nonlimiting example includes the float glass process (i.e., the Pilkington process) and the down-drawing process (i.e., the Corning fusion process). The first pane 112A and the second pane 112B may be decorated using technologies such as and not limited to acid etch, screen printing of frit enamel or paint, and digital printing.

The pair of panes 112 are oriented in fixed positions such that faces thereof are substantially parallel to each other. More specifically, the first pane 112A includes a first outer surface facing a first exterior direction and a second outer surface facing a first interior direction opposite the first exterior direction, and the second pane 112B includes a first outer surface facing a second interior direction aligned with and opposite the first interior direction and a second outer surface facing a second exterior direction aligned with and opposite the second interior direction. Outer edges of the first pane 112A and the second pane 112B are coupled with an outer edge sealing spacer arrangement 110 that seals and maintains an inter-pane space between the pair of panes 112.

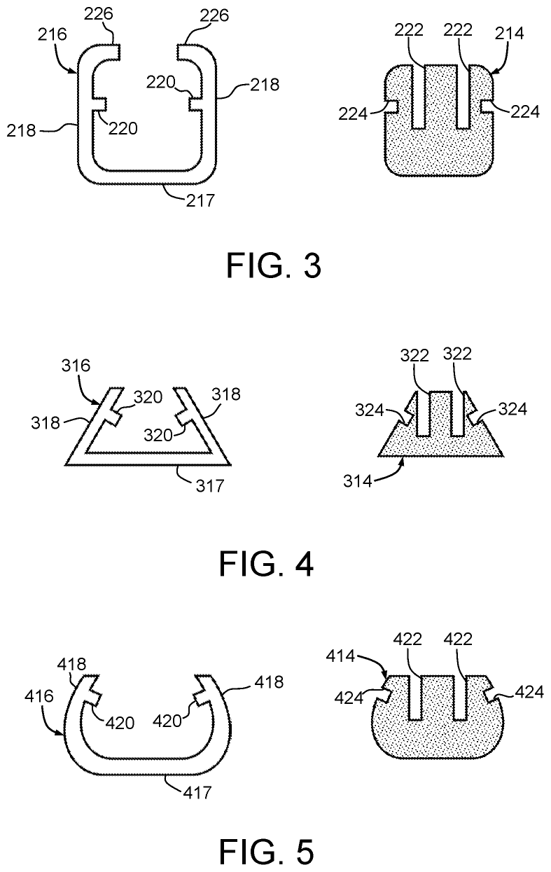

As shown in FIGS. 1 and 2, outer edges of the first pane 112A and the second pane 112B are received within recesses 122 of a seat 114 such that an entirety of the outer edges are surrounded by portions of the seat 114. The seat 114 includes an elongated body that has a substantially rectangular cross-section. However, other cross-sectional shapes are possible. FIGS. 3-5 present additional examples of seats 214, 314, 414 for the outer edge sealing spacer arrangement 110 in accordance with nonlimiting aspects of the disclosure.

FIG. 3 presents the seat 214 as having a cross-sectional shape that defines a partial rectangle with rounded corners. FIG. 4 presents the seat 314 as having a cross-sectional shape that defines a partial or truncated triangle. FIG. 5 presents the seat 414 as having a cross-sectional shape that defines a partial or truncated pear-like shape.

The seats 114, 214, 314, 414 (as well as seats 514, 614, 714 discussed hereinafter) may be formed of various compressible materials that promote a secure hold between the seats 114, 214, 314, 414, 514, 614, 714 and the outer edges of the pair of panes 112 therein. Suitable materials may include, but are not limited to, various natural and synthetic rubber materials, and various compressible polymeric materials. Various methods may be used to produce the seats 114, 214, 314, 414, 514, 614, 714 including but not limited to various extrusion processes.

The seat 114 is fixed within a shoe 116. The shoe 116 includes an elongated body having a base wall 117 and a pair of oppositely disposed side walls 118 extending from the base wall 117. The base wall 117 and the side walls 118 define therebetween a space that receives the seat 114. Distal edges of the side walls 118 define an opening to the space. In this example, the side walls 118 are perpendicular to the base wall 117 and parallel to each other to define a cross-section having a partial or truncated rectangular shape. However, other cross-sectional shapes are possible. FIGS. 3-5 present additional examples of shoes 216, 316, 416 for the outer edge sealing spacer arrangement 110 in accordance with nonlimiting aspects of the disclosure. FIG. 3 presents the shoe 216 as having a cross-sectional shape that defines a partial rectangle with rounded corners. Distal ends of the side walls 218 of the shoe 216 are curved inward toward the inter-pane space (represented at 226). FIG. 4 presents the shoe 316 as having a cross-sectional shape that defines a partial or truncated triangle. FIG. 5 presents the shoe 416 as having a cross-sectional shape that defines a partial or truncated pear-like shape. Notably, the shoes 316, 416 of FIGS. 4 and 5 include a dimension between the side walls 318, 418 and parallel to the base walls 317, 417 that decreases from the base wall 317, 417 to the distal edges. In embodiments such as these, the seats 314, 414 may be tapered to match the space defined by the shoes 316, 416 as presented.

The shoes 116, 216, 316, 416 (as well as the shoes 516, 616, 716 discussed hereinafter) may be formed of various rigid or semi-rigid materials such as, but not limited to, various polymeric, metallic, and composite materials. In one embodiment the shoes 116, 216, 316, 416, 516, 616, 716 are formed of polyvinylchloride (PVC). In another embodiment, the shoes 116, 216, 316, 416, 516, 616, 716 are formed of stainless steel. In yet another embodiment, the shoes 116, 216, 316, 416, 516, 616, 716 are formed of aluminum or an alloy thereof. In yet another embodiment, the shoes 116, 216, 316, 416, 516, 616, 716 are formed of a polymer-wood composite. Various methods may be used to produce the shoes 116, 216, 316, 416, 516, 616, 716 including but not limited to various extrusion processes.

Referring again to FIG. 2, a pair of couplings are located between the seat 114 and the shoe 116 that are configured to promote the seal between the seat 114 and the shoe 116 and thereby substantially seal the inter-pane space. The couplings include ribs or protrusions 120 extending from and along interior sides of the side walls 118 into the space defined by the side walls 118 and the base wall 117 of the shoe 116, and a pair of corresponding grooves or channels 124 in the seat 114. The protrusions 120 are configured to be received within the channels 124 and function therein as barriers that impede relative movement between the seat 114 and the shoe 116 in directions parallel to the pair of panes 112. That is, the protrusions 120 contact interior surfaces of the channels 124 and thereby reduce a likelihood that the seat 114 may move out of the opening of the shoe 116.

FIG. 2 presents the protrusions 120 as having a semi-circular shape. However, other cross-sectional shapes are possible. FIGS. 3-8 present additional examples of couplings for the outer edge sealing spacer arrangement 110 in accordance with nonlimiting aspects of the disclosure. FIGS. 3-6 present protrusions 220, 320, 420, 520 as having a rectangular cross-sectional shape configured to be received within corresponding rectangular-shaped channels 224, 324, 424, 524. FIG. 7 presents protrusions 620 as having a triangular cross-sectional shape configured to be received within a corresponding triangular-shaped channel 624. FIG. 8 represents the side walls 718 of the shoe 716 as each having a pair of semi-circular cross-section protrusions 720 configured to be received within corresponding semicircular channels 724.

The protrusions 120, 220, 320, 420, 520, 620, 720 of the couplings may each include a solid body integral to the shoe 116, a solid body secured to the shoes 116, 216, 316, 416, 516, 616, 716, or a solid body having a coating thereon. The protrusions 120, 220, 320, 420, 520, 620, 720 and/or the coatings thereon may be formed of various materials such as, but not limited to, various polymeric, metallic, and composite materials. In some embodiments, the protrusions 120, 220, 320, 420, 520, 620, 720 include a thermosetting or thermoplastic material. Various methods may be used to produce the protrusions 120, 220, 320, 420, 520, 620, 720 including but not limited to various extrusion processes. If the protrusions 120, 220, 320, 420, 520, 620, 720 include coatings thereon, the coatings may be produced with various deposition processes including but not limited to physical application processes (e.g., painting) and physical vapor deposition (PVD) processes.

Referring again to FIGS. 1 and 2, the inter-pane space between the pair of panes 112, and sealed about the perimeters thereof with the outer edge sealing spacer arrangement 110, is filled with a pressurized gas. The pressurized gas applies forces on the first pane 112A in the first exterior direction, on the second pane 112B in the second exterior direction, and on the seat 114 toward the base wall 117 of the shoe 116. These forces expand and/or stretch the seat 114 in directions toward the side walls 118 and the base wall 117 of the shoe 116. Since the shoe 116 includes a rigid body, a clamping force is effectively applied on the seat 114 that secures the outer edges of the pair of panes 112 in the recesses 122 of the seat 114 and secured the seat 114 within the shoe 116. Exemplary gases suitable for use in pressurizing the inter-pane space include, but are not limited to, gaseous argon and gaseous krypton.

In various embodiments, the outer edge sealing spacer arrangement 110, the pair of panes 112, and other components of the glazing unit 100 do not include a sealant material to, for example, seal the inter-pane space between the pair of panes 112.

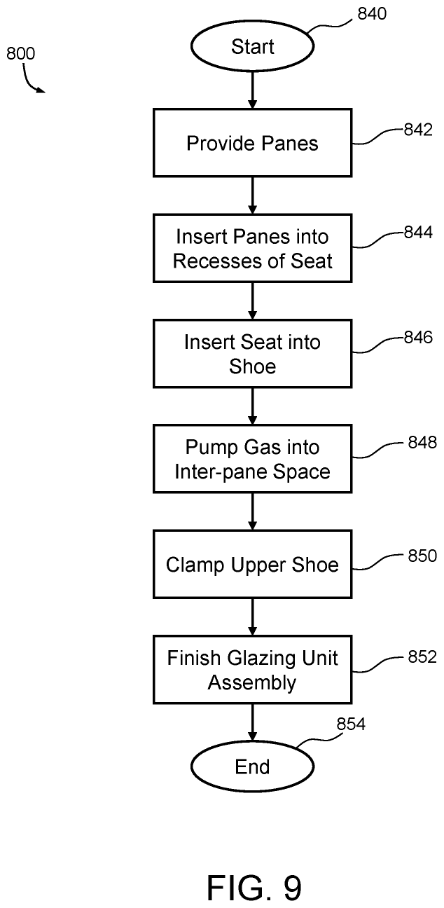

With reference now to FIG. 9 and with continued reference to FIGS. 1-8, a flowchart provides a method 800 for producing a glazing unit, for example, for a fenestration unit, in accordance with exemplary embodiments. As can be appreciated in light of the disclosure, the order of operation within the method 800 is not limited to the sequential execution as illustrated in FIG. 9, but may be performed in one or more varying orders as applicable and in accordance with the present disclosure. For convenience, the method 800 will be described in reference to the embodiment of FIGS. 1 and 2, but the method 800 is not limited to such embodiment.

In one example, the method 800 may begin at 840. The first pane 112A and the second pane 112B may be produced or provided at 842. At 844, the method 800 includes receiving the outer edges of the pair of panes 112 into the recesses 122 of the seat 114 such that the first outer surface of the first pane 112A is facing in the first exterior direction and the second outer surface facing in the first interior direction opposite the first exterior direction, wherein the second pane 112B overlaps the first pane 112A, and the first outer surface of the second pane 112B is facing in the second interior direction that is aligned with and opposite with the first interior direction and the second outer surface facing in the second exterior direction aligned with and opposite the first exterior direction, wherein the seat 114 extends along the outer edges. At 846, the method 800 includes receiving the seat 114 in the shoe 116. At 848, the method 800 include securing the seat 114 in the shoe 116 with the coupling between the seat 114 and the shoe 116 to define the outer edge sealing spacer arrangement 110 that substantially seals and maintains the inter-pane space between the pair of panes 112.

In various embodiments, the outer edges of the pair of panes 112 are surrounded by the seat 114, and the shoe 116 may include the elongated body having the base wall 117 and the pair of oppositely disposed side walls 118 extending from the base wall 117 that define the space therebetween. In such embodiments, the method 800 may include receiving the seat 114 through the opening to the space defined by the distal edges of the side walls 118.

In various embodiments, the method 800 may include securing the seat 114 in the shoe 116 by locating the protrusions 120 extending from the shoe 116 in the channels 124 in the seat 114.

In various embodiments, the method 800 may include filling the inter-pane space with the gas to apply a pressure on the seat 114 sufficient to expand the seat 114 and thereby promote an integrity of the seal of the inter-pane space.

In various embodiments, the method 800 does not include using a sealant material on the outer edge sealing spacer arrangement 110, the pair of panes 112, or any other component of the glazing unit 100 to seal the inter-pane space between the pair of panes 112.

Although the glazing unit 100 has been described herein as including only the first pane 112A and the second pane 112B, the glazing unit 100 may include additional panes 112, such as three or four spaced apart, parallel panes 112. In such embodiments, the additional panes 112 may be secured in corresponding recesses 124/224/324/424/524/624/724 of the seat 114/214/314/414/514/614/714 in the same manner as described for the first pane 112A and the second pane 112B. Further, once the outer edge sealing spacer arrangement 110 has been assembled with all of the panes 112 secured in the seat 114/214/314/414/514/614/714, any inter-pane spaces between the panes 112 are substantially sealed.

In such embodiments the method 800 of producing the glazing unit 100 may include additional steps such as (referring again to the embodiment of FIGS. 1-2) providing a third pane having a third outer edge, receiving the third pane in the seat 114 such that a first outer surface of the third pane faces in a third interior direction aligned with and opposite the first interior direction and a second outer surface facing in a third exterior direction aligned with and opposite the first exterior direction, wherein the third pane overlaps the second pane 112B, receiving the seat 114 in the shoe 116, and securing the seat 114 in the shoe 116 with a coupling between the seat 114 and the shoe 116 to define the outer edge sealing spacer arrangement 110 that substantially seals and maintains a second inter-pane space between the second pane 112B and the third pane. The seat 114 may receive the third outer edge and extend along the third outer edge, and the coupling may substantially seal the second inter-pane space. Similar method steps may be used for glazing units having additional panes, such as a fourth pane.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An insulated glazing unit comprising:
a first pane with a first outer surface facing in a first exterior direction and a second outer surface facing in a first interior direction, the first pane including a first outer edge;
a second pane that overlaps the first pane and that includes a first outer surface facing in a second interior direction that is aligned with and opposite the first interior direction and a second outer surface facing in a second exterior direction that is aligned with and opposite the first exterior direction, the second pane including a second outer edge;
an outer edge sealing spacer arrangement that seals and maintains an inter-pane space between the first pane and the second pane, the outer edge sealing spacer arrangement including:
a seat that receives the first outer edge and the second outer edge and that extends along the first outer edge and the second outer edge;
a shoe that receives the seat; and
a coupling between the seat and the shoe configured to maintain the seat within the shoe.

2. The insulated glazing unit of claim 1, wherein the seat includes a body having a first recess that receives the first outer edge and a second recess that receives the second outer edge, where the first outer edge and the second outer edge are surrounded by the body.

3. The insulated glazing unit of claim 1, wherein the shoe includes an elongated body having a base wall and a pair of oppositely disposed side walls extending from the base wall, wherein the base wall and the side walls define therebetween a space that receives the seat, wherein distal edges of the side walls define an opening to the space configured to receive the seat therethrough.

4. The insulated glazing unit of claim 3, wherein the distal edges of the side walls curve toward each other.

5. The insulated glazing unit of claim 3, wherein a dimension between the side walls and parallel to the base wall decreases from the base wall to the distal edges of the side walls.

6. The insulated glazing unit of claim 1, wherein the coupling includes at least one protrusion extending from the shoe that is configured to be received within a corresponding channel of the seat.

7. The insulated glazing unit of claim 6, wherein the seat includes a recess that receives the at least one protrusion of the coupling.

8. The insulated glazing unit of claim 1, wherein the inter-pane space is filled with a gas that applies a pressure on the seat sufficient to expand the seat and thereby promote an integrity of the seal of the inter-pane space.

9. The insulated glazing unit of claim 1, wherein the seat includes a polymeric material or a rubber material.

10. The insulated glazing unit of claim 1, wherein the shoe includes a polymeric material, a metallic material, or a composite material.

11. The insulated glazing unit of claim 1, wherein the coupling includes a polymeric material.

12. The insulated glazing unit of claim 1, further comprising a third pane that overlaps the second pane and that includes a first outer surface facing in a third interior direction aligned with and opposite the first interior direction and a second outer surface facing in a third exterior direction aligned with and opposite the first exterior direction, the third pane including a third outer edge, wherein the outer edge sealing spacer arrangement seals and maintains a second inter-pane space between the second pane and the third pane, the seat receives the third outer edge and extends along the third outer edge, and the coupling substantially seals the second inter-pane space.

13. The insulated glazing unit of claim 11, further comprising multiple additional panes that overlap the second pane and that each includes a first outer surface facing in other interior directions aligned with and opposite the first interior direction and a second outer surface facing in other exterior directions aligned with and opposite the first exterior direction, the multiple additional panes each include an outer edge, wherein the outer edge sealing spacer arrangement seals and maintains additional inter-pane spaces between the second pane and the multiple additional panes, the seat receives the outer edges of each of the multiple additional panes and extends therealong, and the coupling substantially seals the additional inter-pane spaces.

14. The insulated glazing unit of claim 1, wherein the outer edge sealing spacer arrangement does not include a sealant material.

15. A method of producing an insulated glazing unit comprising:
providing a first pane and a second pane, the first pane including a first outer edge and the second pane including a second outer edge;
receiving the first outer edge and the second outer edge into a seat such that a first outer surface of the first pane is facing in a first exterior direction, a second outer surface of the first pane is facing in a first interior direction opposite the first exterior direction, the second pane overlaps the first pane, a first outer surface of the second pane is facing in a second interior direction aligned with and opposite the first interior direction, and a second outer surface of the second pane is facing in a second exterior direction aligned with and opposite the first exterior direction, wherein the seat extends along the first outer edge and the second outer edge;
receiving the seat in a shoe; and
securing the seat in the shoe with a coupling between the seat and the shoe to define an outer edge sealing spacer arrangement that substantially seals and maintains an inter-pane space between the first pane and the second pane.

16. The method of claim 15, wherein the first outer edge is received in a first recess of the seat and the second outer edge is received in a second recess of the seat, where the first outer edge and the second outer edge are surrounded by the seat, wherein the shoe includes an elongated body having a base wall and a pair of oppositely disposed side walls extending from the base wall that define a space therebetween, wherein the seat is received through an opening to the space defined by distal edges of the side walls.

17. The method of claim 15, wherein securing the seat in the shoe includes locating at least one protrusion extending from the shoe in a channel of the seat.

18. The method of claim 15, further comprising filling the inter-pane space with a gas to apply a pressure on the seat sufficient to expand the seat and thereby reduce a likelihood of the seat moving out of the shoe.

19. The method of claim 15, further comprising:
providing a third pane including a third outer edge;
receiving the third pane in the seat such that a first outer surface of the third pane faces in the second interior direction, a second outer surface of the third pane faces in the second exterior direction, and the third pane overlaps the second pane;
receiving the seat in the shoe; and
securing the seat in the shoe with a coupling between the seat and the shoe to define the outer edge sealing spacer arrangement that substantially seals and maintains a second inter-pane space between the second pane and the third pane, wherein the seat receives the third outer edge and extends along the third outer edge, and the coupling reduces a likelihood of the seat moving out of the shoe.

20. The method of claim 15, wherein the method does not include using a sealant material on the outer edge sealing spacer arrangement, on the first pane, or on the second pane to seal the inter-pane space between the first pane and the second pane.
